(19) United States
(12) Patent Application Publication
(10) Pub. No.: US 2009/0026648 A1
(43) Pub. Date: Jan. 29, 2009

(54) VARIEGATED BUILDING PRODUCT FORMING PROCESS

(75) Inventors: JIM STEVENSON, Lamar, MO (US); DAN ROBINSON, Bolivar, MO (US); MIKE LACEY, Carthage, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: EPOCH COMPOSITE PRODUCTS, INC., Joplin, MO (US)

(21) Appl. No.: 11/782,785

(22) Filed: Jul. 25, 2007

(51) Int. Cl. B29C 41/22

(52) U.S. Cl. 264/73; 425/585

(57) ABSTRACT

A variegated building product solution includes a process for creating variegated building products through the introduction of color infused pellets with base pellets to create an aggregate, non-uniformly mixed pellet mixture as feed material for a molding process. In one aspect, the process involves the introduction of a set of color infused pellets into the stream of feed material pellets at preselected intervals. The feed material pellets includes color of a first hue, and the set of color infused pellets possess at least a second hue at variance from the first hue, such that the combined pellets form the aggregate, non-uniformly mixed pellet mixture. According to the process, the aggregate pellet mixture is moved into a molding chamber for molding of the aggregate pellet mixture into a variegated building product.

### BACKGROUND

For many years, composite building products such as roofing shingles, decking boards, and the like, have been fabricated with color variance across visible surfaces of the products. Such a color variance enables these building products to mimic visual characteristics of building products formed from naturally-occurring materials, such as wood planks, slate shingles, etc. However, many processes for forming composite building products with color variation require excessively complex machinery or specialized building material feedstock that ultimately add to the complexity of the respective process. For instance, some compression molding techniques require the use of multiple types of building material feedstock having a large variance in melt flow characteristics (e.g., polymer melting temperature) in order to form a building product with any appreciable variance in color across the molded surface.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A solution is provided for forming a variegated building product. Although not limited to a single application, the solution is well suited for forming composite roofing shingles through injection molding. In one aspect, the variegated building product forming process involves the introduction of a set of color infused pellets into the stream of feed material pellets at preselected intervals. The feed material pellets includes color of a first hue, and the set of color infused pellets possess at least a second hue at variance from the first hue, such that the combined pellets form an aggregate, non-uniformly mixed pellet mixture. According to the process, the aggregate pellet mixture is moved into a molding chamber for molding of the aggregate pellet mixture into a variegated building product. The set of color infused pellets may be introduced into the stream of feed material pellets close to the molding chamber, to aid in the non-uniformity of the pellet mixture and thus the desired variegated effect of the finished product.

In another aspect, a system is provided for forming variegated building product. Accordingly, the system includes a mixer for randomly combining a first type of feed material pellet and a second type of feed material pellet into a stream of feed material pellets, a molding chamber, an enclosed pathway extending between the mixer and the molding chamber, as well as one or more concentrate feeders. The pathway extends from a mixer outlet to a molding chamber feed throat inlet and the concentrate feeders are configured to introduce color infused pellets at preselected intervals into the stream of feed material pellets within the enclosed pathway to form an aggregate, non-uniformly mixed pellet mixture for introduction into the feed throat of the molding chamber.

Additional advantages and features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a front view of a variegated building product forming system in accordance with one embodiment of the present invention;

FIG. 2 is a side view of the variegated building product forming system of FIG. 1;

FIG. 3 is a top view of the variegated building product forming system of FIG. 1; and

FIG. 4 is a flow diagram representative of a process for forming a variegated building product in accordance with one embodiment of the present invention.

### DETAILED DESCRIPTION

Embodiments of the present invention relate to a solution for forming variegated building products. In particular, the solution involves the introduction of color infused pellets at a desired point in the flow of feed material pellets moving towards a molding chamber, at certain intervals, to form a non-uniformly mixed aggregate pellet mixture for molding into a variegated building product. The solution significantly reduces or eliminates the need to procure color pellets of significantly varying melt flow characteristics (e.g., polymer melting temperature) as feedstock in order to form a building product with any appreciable variance in color across the molded surface.

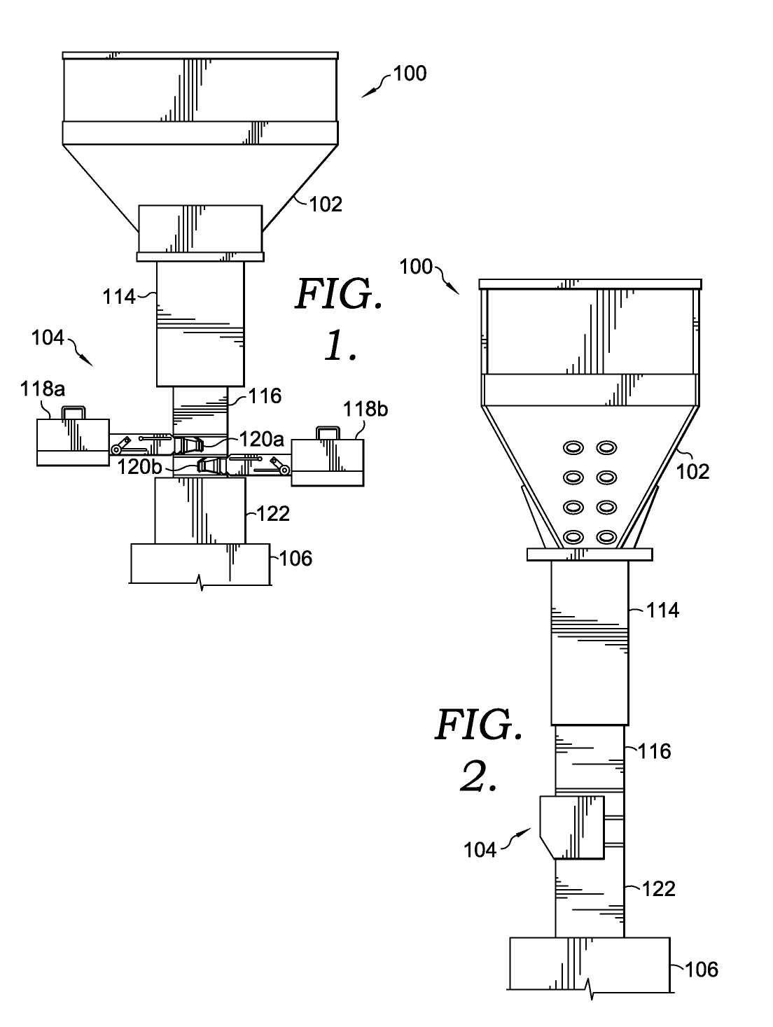

Turning now to FIGS. 1-3, a variegated building product forming system 100 is shown generally. The system 100 includes a pellet mixer 102, a enclosed pathway (formed by parts 114 and 116) or duct, a pellet feeding apparatus 104, and a molding machine 106. General compound pellets, and optional base color pellets or other additive pellets, are fed to the pellet mixer 102 to serve as base or feed material pellets for forming the composite material products. According to one general process known to those of skill in the art, compound pellets may be initially formed via use a mixer and extruder. The raw ingredients for the compound pellets, such as wood or other cellulosic fiber, and various polymer fillers are mixed in the mixer (e.g., a kinetic mixer) and then passed through the extruder. The mixture emerging from the extruder may be sliced into small pellets by a rotary knife so that the material can be more easily conveyed through piping under air pressure or suction to a storage location for use when needed (e.g., in a storage bin). Thereafter, the pellets are extracted from storage and fed a melting chamber along with colorant or other additives (e.g., binders) to create the compound pellets. As can be understood, the compound pellets serve as the primary base material for forming the composite building products. Depending on how much colorant is present in the compound pellets, the base color pellets may or may not be utilized in the system 100. In any event, the base material pellets, considered in viewing either the added color polymers or the given colors of the raw ingredients forming the compound pellets, visually provide at least one color hue.

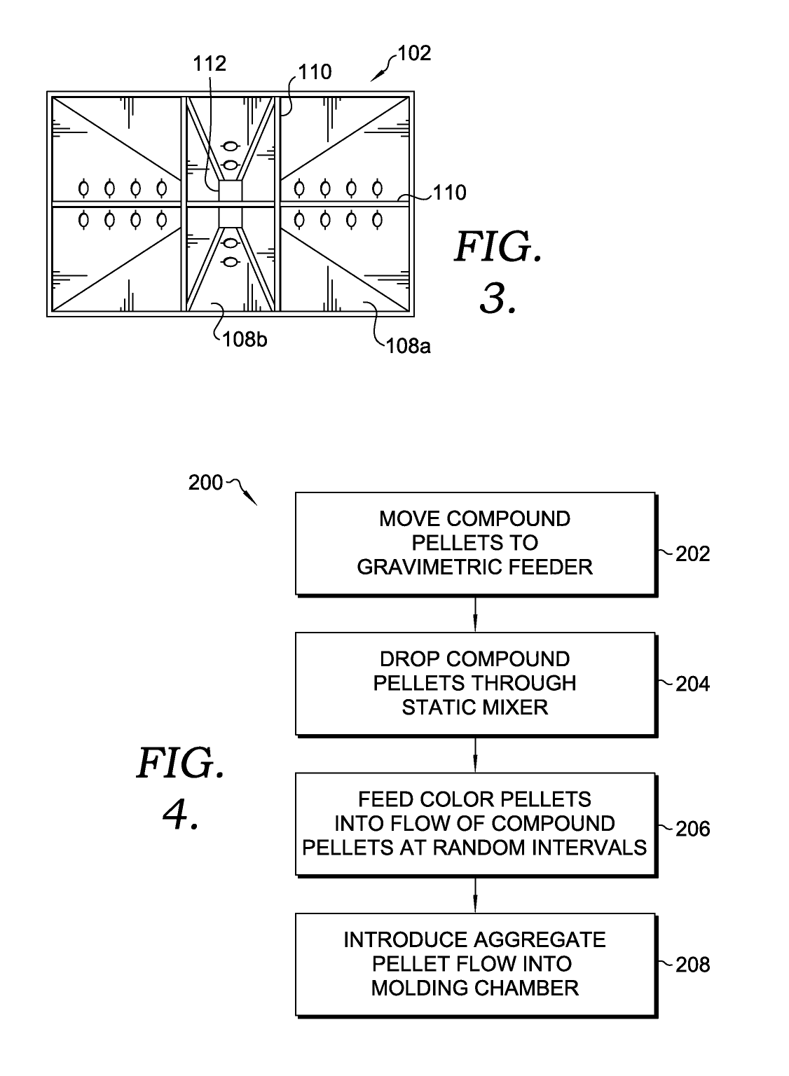

With specific reference to FIG. 3, the pellet mixer 102 may take the form of a static mixer without moving parts. In use, the base material pellets are dropped into the top of the static mixer 102 through different sized openings 108a and 108b formed by the perimeter wall of the mixer 102 and a set of cross dividers 110. The base material pellets fall through the openings 108 and 108b and are directed through an outlet 112 of the mixer 102. The object is for the base material pellets, such as the combination of general compound pellets and base color pellets, to be more uniformly mixed upon leaving the mixer 102. It should also be understood that the specific pellet mixer 102 depicted in FIG. 3 is exemplary, and other configurations are suitable for use with the system 100, including static and dynamic mixers.

As depicted in FIGS. 1-3, the portion of the system between the pellet mixer 102 and the molding machine 106 where the base material pellets are in motion is preferably a substantially or wholly gravity fed system, so that other conveying means is not necessary to move the pellets. Upon moving through the outlet 112, the base material pellets fall through a first duct portion 114 of the enclosed pathway and into a more narrow second duct portion 116. The pellet feeding apparatus 104 has an output located within the second duct portion 116, and generally includes one or more pellet feeding machines (for instance, machines 118a and 118b). Each pellet feeding machine 118a and 118b is configured to feed one or more feedstocks of color infused pellets into the stream of base material pellets falling through the second duct portion 116, and optional guide plates 120a and 102b may guide the direction of the color pellet outputs, to lessen the degree of mixing of the color infused pellets with the base material pellets. As the term is used herein, “aggregate pellet mixture” refers to the combination of the base material pellets and the color infused pellets flowing together downstream of the pellet feeding apparatus 104.

The outputs of the pellet feeding machine 118a and 118b may be at the same level in the stream of falling base material pellets, or adjacent to one another, such that one of the outputs is more downstream in the flow through the second duct portion 116. Preferably, the outputs of the pellet feeding machines 118a and 118b place the color infused pellets into the flow of base material pellets near a feed throat 122 of the molding machine 106, which also lessens the degree of mixing of the color infused pellets with the base material pellets. This is desirable because more non-uniform mixing of the aggregate pellet mixture entering a molding chamber of the molding machine 106 provides a finished molded building product with a more variegated look. At or near the feed throat 122, the pellets of the aggregate pellet mixture become melted for injection into the molding chamber; however, uniform color mixing does not occur because of the proximity of the outputs of the pellet feeding machines 118a and 118b to the injection point. Although other methods may be employed, the aggregate pellet mixture is preferably injected into the molding chamber from the feed throat 122, within a cycle of injection molding to form the finished variegated building product.

The pellet feeding machines 118a and 118b may each handle a color infused pellets of a single hue, or multiple hues, depending on the desired variegated effect in the finished molded product. Additionally, the color infused pellets are preferably fed into the base material pellet flow at preselected, random intervals, for increase non-uniformity and variegation in the molded product. For instance, a computer program may be utilized to control the output of the pellet feeding machines 118a and 118b. The program may take into account, for example, the following factors: the quantity of color infused pellets added to the raw material flow in a given molding cycle of the molding machine 106, as well as the rate at which the pellets are added; the temporal point in the injection cycle when the color infused pellets are fed into the material flow; whether to skip feeding color infused pellets for one or more injection cycles; and coordination of pellet introduction patters between the pellet feeding machines 118a and 118b when two or more hues of color infused pellets are being utilized. Certain of these factors, in bringing about the variegated effect, may be emphasized over other factors, and this emphasis may change over time.

Turning to FIG. 4, one exemplary process for forming a variegated building product is depicted in flow diagram 200. According to process, raw materials in the form of compound pellets (and optionally base color pellets) are moved from a storage location to a gravimetric feeder, in step 202. Such raw materials, or base material pellets including the compound pellets, are then dropped through a static mixer to provide a generally uniform and evenly distributed flow of the base material pellets emerging from the mixer, in step 204. Downstream of the static mixer, color infused pellets are introduced into the base material pellet flow at preselected, random intervals, in step 206, thereby forming the aggregate pellet mixture. Thereafter, in step 208, the aggregate pellet mixture flow is introduced into the molding chamber, such as by injection or other methods depending on the type of molding process utilized to manufacture the variegated building product.

It should be appreciated by those skilled in the art that above described solution for forming a variegated building product is not limited to what has been particularly shown and described above. Rather, all matter shown in the accompanying drawings or described above is to be interpreted as illustrative and not limiting. Accordingly, the scope of the present invention is defined by the appended claims rather than the foregoing description.

What is claimed is:

1. A process for forming a variegated building product, comprising:
providing a stream of feed material pellets, the feed material pellets including at least some added color having a first hue;
introducing a set of color infused pellets into the stream of feed material pellets at preselected intervals to form an aggregate, non-uniformly mixed pellet mixture, the set of color infused pellets possessing at least a second hue at variance from the first hue; and
moving the aggregate pellet mixture into a molding chamber, whereby molding of the aggregate pellet mixture produces a variegated building product.

2. The process of claim 1, wherein the stream of feed material pellets is provided from a static mixer.

3. The process of claim 1, wherein providing a stream of feed material pellets includes dropping the stream of feed material from a mixer.

4. The process of claim 1, wherein the set of color infused pellets includes a first subset of color infused pellets possessing the second hue and second subset of color infused pellets possessing a third hue at variance from the first hue and the second hue.

5. The process of claim 1, wherein the set of color infused pellets are introduced into the stream of feed material pellets at preselected, varying intervals depending on current injection molding cycle activity within the molding chamber.

6. The process of claim 1, wherein the molding chamber includes a feed throat, and wherein the set of color infused pellets are introduced into the stream of feed material pellets proximal to the feed throat.

7. A system for forming a variegated building product, comprising:
a mixer for randomly combining a first type of feed material pellet and a second type of feed material pellet into a stream of feed material pellets, the mixer having an outlet;
a molding chamber having a feed throat;
an enclosed pathway extending from the outlet of the mixer to the feed throat of the molding chamber and adapted to convey a stream of feed material pellets; and
one or more concentrate feeders configured to introduce color infused pellets at preselected intervals into the stream of feed material pellets within the enclosed pathway to form an aggregate, non-uniformly mixed pellet mixture for introduction into the feed throat of the molding chamber.

8. The system of claim 7, wherein the mixer is a static mixer.

9. The system of claim 7, wherein the enclosed pathway is formed as a vertically-oriented duct to facilitate the stream of feed material pellets dropping from the outlet of the mixer to the feed throat of the molding chamber.

10. The system of claim 7, wherein the one or more concentrate feeders are configured to introduce the color infused pellets into the stream of feed material pellets at preselected, varying intervals depending on current injection molding cycle activity within the molding chamber.

11. The system of claim 7, wherein the one or more concentrate feeders are positioned to introduce color infused pellets into the stream of feed material pellets proximal to the feed throat of the molding chamber.

12. The system of claim 7, wherein the one or more concentrate feeders includes a pair of concentrate feeders, each of the concentrate feeders being adapted to introduce color infused pellets of a different hue than a hue of the color infused pellets of the other one of the concentrate feeders.
